(19) United States
(12) Patent Application Publication
(10) Pub. No.: US 2007/0230877 A1
(43) Pub. Date: Oct. 4, 2007

(54) COEXISTENT OPTICAL-ELECTRICAL CONNECTOR

(76) Inventor: Chun-Ying Liao, Taoyuan Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/308,476

(22) Filed: Mar. 29, 2006

(51) Int. Cl. G02B 6/36

(52) U.S. Cl. 385/92; 385/88

(57) ABSTRACT

A coexistent optical-electrical connector having an insulating housing, an optical-electrical identity module, a multiple of electrical signal terminals and an optical-electrical transform module is provided. The insulating housing comprises an insertion hole, a chamber, and a multiple of plugging grooves. The insertion hole is connected through to the chamber. The plugging grooves disposed near one side of the chamber are also connected through to the chamber. The optical-electrical identity module comprises an identity unit and a first terminal and a second terminal connected to the identity unit. The first/second terminals are disposed respectively in the plugging grooves. Furthermore, the first/second terminal has a first/second contact portions that extend into the chamber. In addition, the electrical signal terminals are disposed on their corresponding plugging grooves and the optical-electrical transform module is disposed inside the chamber.

### BACKGROUND OF THE INVENTION

1. Field of the Invention

The present invention relates to a connector. More particularly, the present invention relates to a coexistent optical-electrical connector.

2. Description of the Related Art

In this multi-media world, most home electronics products are equipped with an audio plug for transmitting voice messages. However, when an audio plug is used in signal transmission, the audio signal is often distorted due to electromagnetic interference. Hence, fiber optic has become an alternative means of transmitting audio signals. Because optical fiber has a high transmission rate and efficiency and less vulnerable to electromagnetic interference, optical fiber techniques have great potential in the development of signal transmission system and the communication industry.

Although the audio plug and the fiber-optic plug have a very similar shape and external appearance, the electrical connector and optical fiber connectors are installed separately for users in most outlets of electronic products. Thus, if the home appliance has a limited internal space, it is difficult to install both the electrical connector and the optical fiber connector inside the same home appliance without causing problems. Moreover, separate installing the electrical connector and the optical fiber connector inside the same home appliance will require more assembling time and hence a higher production cost.

### SUMMARY OF THE INVENTION

Accordingly, at least one objective of the present invention is to provide a coexistent optical-electrical connector that can reduce the space required for accommodating an optical fiber connector and an electrical connector.

At least another objective of the present invention is to provide a coexistent optical-electrical connector capable of reducing the cost of fabricating a home electrical appliance.

To achieve these and other advantages and in accordance with the purpose of the invention, as embodied and broadly described herein, the invention provides a coexistent optical-electrical connector suitable for connecting with an electrical plug or an optical plug. The electrical plug is suitable for transmitting an electrical signal and the optical plug is suitable for transmitting an optical signal. The coexistent optical-electrical connector comprises an insulating housing, an optical identity module, a multiple of electrical signal terminals and an optical-electrical transform module. The insulating housing has an insertion hole, a chamber, and a multiple of plugging grooves. The insertion hole is connected through to the chamber. The plugging grooves disposed near one side of the chamber are also connected through to the chamber. The optical-electrical identity module comprises an identity unit and a first terminal and a second terminal connected to the identity unit. The first and the second terminals are disposed respectively in the plugging grooves. Furthermore, the first terminal has a first contact portion that extends into the chamber and the second terminal has a second contact portion that extends into the chamber. In addition, the electric-signal terminals are disposed on their corresponding plugging grooves. When the electrical plug is inserted into the chamber, the first contact portion is electrically connected to the second contact portion through the electrical plug. The identity unit drives the electrical signal terminal to transmit electrical signals. The optical-electrical transform module is disposed inside the chamber. When the optical fiber plug is inserted into the chamber, the optical-electrical transform module will initiate the transmission of optical signals.

In one embodiment of the present invention, the coexistent optical-electrical connector further comprises a base with a plurality of through holes. The insulating housing is disposed on the base, for example. Furthermore, the through holes can serve as positioning guides for inserting the electrical signal terminals.

In one embodiment of the present invention, the coexistent optical-electrical connector further comprises a shielding housing. The shielding housing encapsulates the insulating housing, for example.

In one embodiment of the present invention, the optical-electrical transform module has an optical-electrical transform device aligned with the insertion hole. When the optical fiber plug is inserted into the chamber, the optical fiber plug and the optical-electrical transform device together form an optical-electrical transform circuit.

In one embodiment of the present invention, the optical-electrical transform module further comprises a plurality of signal terminals for transmitting the signals transformed by the optical-electrical transform device.

Accordingly, the present invention comprises an additional optical-electrical identity module in the connector so that the connector has the capability to identify an electrical plug and an optical fiber plug so that the electrical signal processing system or the optical signal processing system is activated.

It is to be understood that both the foregoing general description and the following detailed description are exemplary, and are intended to provide further explanation of the invention as claimed.

### BRIEF DESCRIPTION OF THE DRAWINGS

The accompanying drawings are comprised to provide a further understanding of the invention, and are incorporated in and constitute a part of this specification. The drawings illustrate embodiments of the invention and, together with the description, serve to explain the principles of the invention. In the drawings,

FIG. 1 is a perspective view of an assembled coexistent optical-electrical connector according to one preferred embodiment of the present invention.

FIGS. 2 and 3 are perspective views showing dissociated coexistent optical-electrical connectors according to one preferred embodiment of the present invention.

FIG. 4 is a perspective view showing a dissociated coexistent optical-electrical connector without an optical-electrical transform module according to one preferred embodiment of the present invention.

FIG. 5 is a perspective cross-sectional view of a coexistent optical-electrical connector according to one preferred embodiment of the present invention.

FIG. 6 is a cross-sectional view of a coexistent optical-electrical connector of the present invention after plugging in an electrical plug.

FIG. 7 is a perspective view showing the connection of the first terminal and the second terminal of an electrical plug after plugging into the coexistent optical-electrical connector of the present invention.

FIG. 8 is a cross-sectional view of a coexistent optical-electrical connector of the present invention after inserting an optical fiber plug.

FIG. 9 is a perspective view showing the connection of the first terminal and the second terminal of an optical fiber plug after plugging into the coexistent optical-electrical connector of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

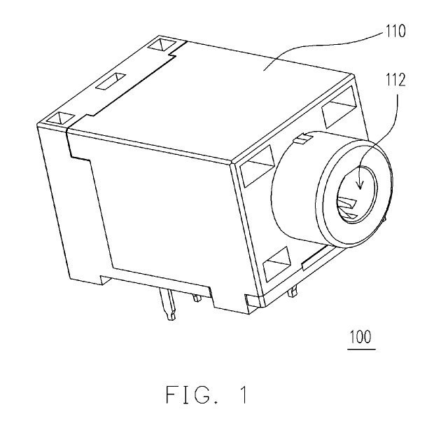

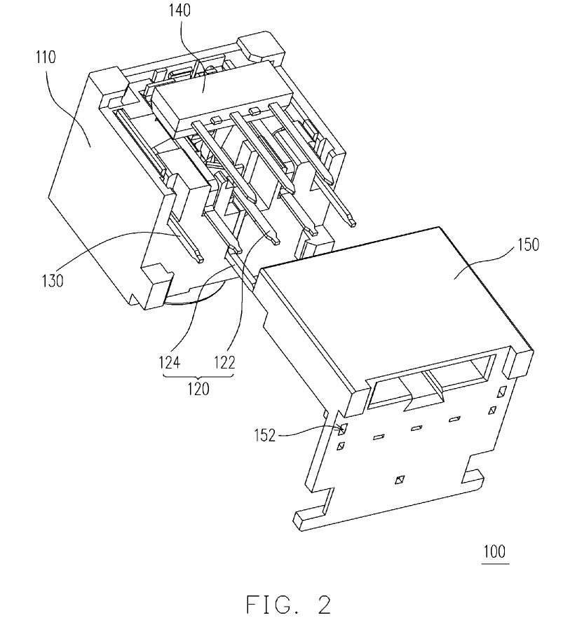

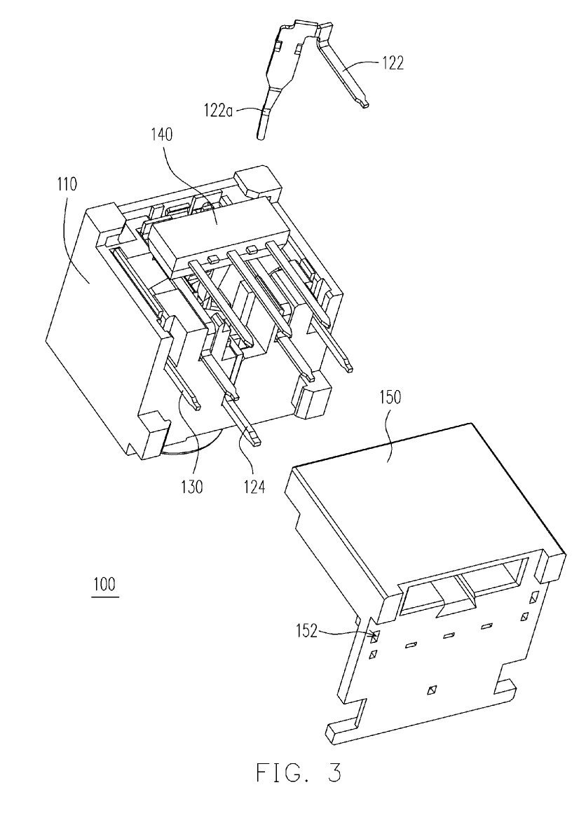

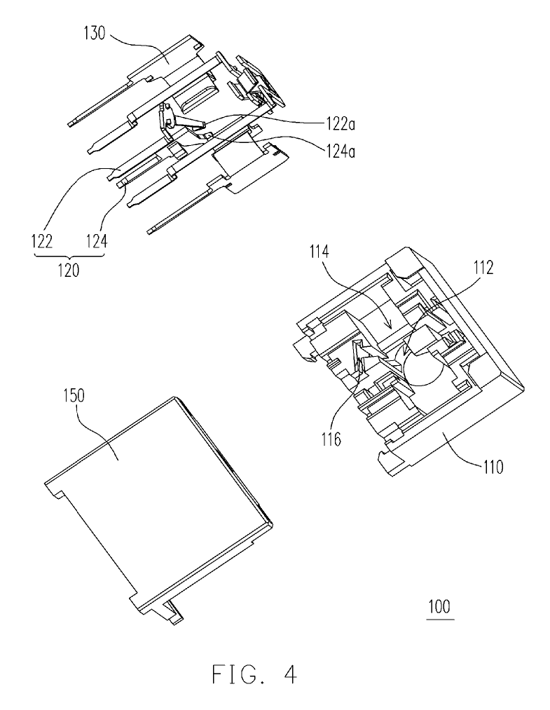

The coexistent optical-electrical connector in the present invention is adapted to be disposed in most home audio/video products for connecting with an external electrical plug or an optical fiber plug. FIG. 1 is a perspective view of an assembled coexistent optical-electrical connector according to one preferred embodiment of the present invention. FIGS. 2 and 3 are perspective views showing dissociated coexistent optical-electrical connectors according to one preferred embodiment of the present invention. FIG. 4 is a perspective view showing a dissociated coexistent optical-electrical connector without an optical-electrical transform module according to one preferred embodiment of the present invention. As shown in FIGS. 1, 2, 3 and 4, the coexistent optical-electrical connector 100 in the present invention is suitable for connecting with an electrical plug or an optical fiber plug. The electrical plug is suitable for transmitting an electrical signal and the optical fiber plug is suitable for transmitting an optical signal. The coexistent optical-electrical connector 100 of the present embodiment comprises an insulating housing 110, an optical-electrical identity module 120, a multiple of electrical signal terminals 130 and an optical-electrical transform module 140. In the present embodiment, the insulating housing 110 has an insertion hole 112, a chamber 114, a multiple of plugging grooves 116. The insertion hole 112 is connected through to the chamber 114. The plugging grooves 116 are disposed near one side of the chamber 114 and are also connected through to the chamber 114.

The optical-electrical identity module 120 comprises an identity unit (not shown) and a first terminal 122 and a second terminal 124 connected to the identity unit (not shown). The first terminal 122 and the second terminal 124 are disposed within the respective plugging grooves 116. Furthermore, the first terminal 122 has a first contact portions 122a that extends into the chamber 144 and the second terminal 124 has a second contact portions 124a that extends into the chamber 114. In a similar way to the first terminal 122 and the second terminal 124, the electrical signal terminals 130 are disposed on their corresponding plugging grooves 116.

Additionally, in the present embodiment, the coexistent optical-electrical connector 100 can also comprise a base 150 with a plurality of through holes 152. The insulating housing 110 is disposed on the base 150, for example. Furthermore, the through holes 152 can also serve as positioning guide for inserting the electrical signal terminals 130.

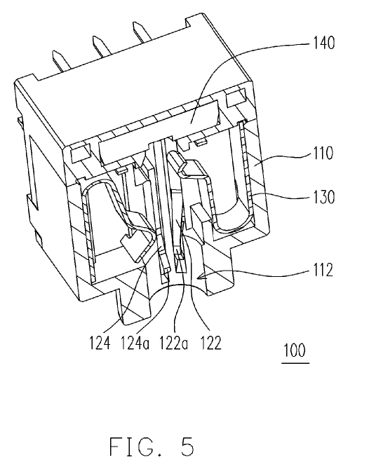

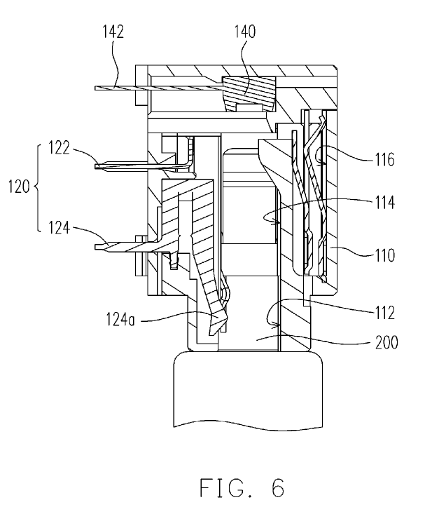

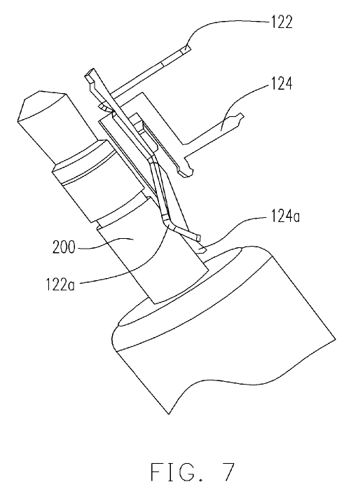

FIG. 5 is a perspective cross-sectional view of a coexistent optical-electrical connector according to one preferred embodiment of the present invention. FIG. 6 is a cross-sectional view of a coexistent optical-electrical connector of the prevent invention after plugging in an electrical plug. FIG. 7 is a perspective view showing the connection of the first terminal and the second terminal of an electrical plug after plugging into the coexistent optical-electrical connector of the present invention. As shown in FIGS. 5, 6 and 7, after inserting the electrical plug 200 into the chamber 114 of the coexistent optical-electrical connector 100, the first contact portion 122a is electrically connected to the second contact portion 124a through the electrical plug 200. This is because the particular section of the chamber 114 that the electrical plug 200 is plugged into is conductive. Hence, the identity unit (not shown) can immediately determine the plug inserted into the chamber 114 is an electrical plug 200 and drive the electrical signal transmission between the electrical signal terminal 130 and the electrical plug 200.

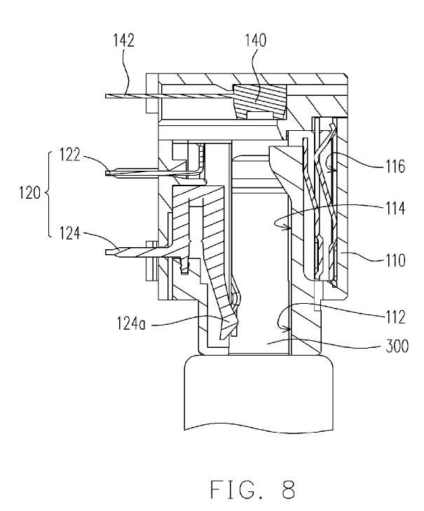

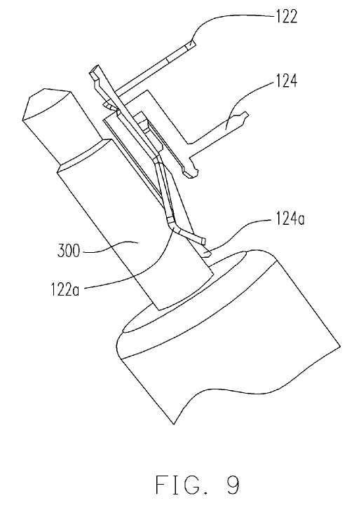

FIG. 8 is a cross-sectional view of a coexistent optical-electrical connector of the present invention after inserting a fiber-optic plug. FIG. 9 is a perspective view showing the connection of the first terminal and the second terminal of an optical fiber plug after plugging into the coexistent optical-electrical connector of the present invention. As shown in FIGS. 4, 8 and 9, after inserting the optical fiber plug 300 into the chamber 114 of the coexistent optical-electrical connector 100, the first contact portion 122a cannot connect electrically with the second contact portion 124a through the optical fiber plug 300. This is because the particular section of the chamber 114 that the optical fiber plug 300 is plugged into is non-conductive. Hence, the identity unit (not shown) can immediately determine the plug inserted into the chamber 114 is an optical fiber plug 300 so that the optical-electrical transform module 140 can perform optical signal transmission with the optical fiber plug 300. In one preferred embodiment, the optical-electrical transform module 140 can have a plurality of signal terminals 142 and an optical-electrical transform device (not shown) aligned with the insertion hole 112. Therefore, when the optical fiber plug 300 is inserted into the chamber 114, the optical fiber plug 300 and the optical-electrical transform device (not shown) can form an optical-electrical transform circuit to covert the optical signals provided by the optical fiber plug 300 into electrical signals. Meanwhile, the signal terminal 142 can transmit the electrical signal to the interior of the home appliance. Obviously, the electrical signals demanded by the interior of the home appliance can be delivered to the optical-electrical transform device through the signal terminal 142 for converting into optical signals and the optical signals are transmitted to external device through the optical fiber plug 300.

In one embodiment, the coexistent optical-electrical connector 100 further comprises a shielding housing (not shown). The shielding housing (not shown) encapsulates the insulating housing 110 so that the signal transmission within the coexistent optical-electrical connector is shielded against any interference from external electromagnetic wave.

In summary, the present invention comprises disposing an optical-electrical identity module inside a coexistent optical-electrical connector. Therefore, the type of plug (an optical fiber plug or an electrical plug) inserted into the chamber can be determined through the presence or absence of an electrical connection between the first terminal and the second terminal and the required optical signal/electrical signal can be transmitted. Compared with the conventional technique, the present invention integrates the conventional electrical connector and the conventional optical fiber connector together to produce a single coexistent optical-electrical connector so that only one coexistent optical-electrical connector is required in a home appliance for plugging with an electrical plug and optical fiber plug. In other words, the coexistent optical-electrical connector in the present invention has a lower material cost and shorter assembling time. Moreover, the space inside the home appliance for housing the coexistent optical-electrical connector is substantially smaller than the space for accommodating an electrical connector and an optical fiber connector separately.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A coexistent optical-electrical connector suitable for connecting with an electrical plug or an optical fiber plug, wherein the electrical plug is suitable for transmitting an electrical signal and the optical fiber plug is suitable for transmitting an optical signal, the coexistent optical-electrical connector comprising:
an insulating housing having an insertion hole, a chamber and a multiple of plugging grooves, wherein the insertion hole is connected through to the chamber, the plugging grooves are disposed on one side of the chamber and connected through to the chamber;
an optical-electrical identity module having an identity unit and a first terminal and a second terminal connected to the identity unit, wherein the first terminal and the second terminal are disposed respectively in the plugging groove, and furthermore, the first terminal has a first contact portion that extends into the chamber and the second terminal has a second contact portion that extends into the chamber;
a plurality of electrical signal terminals disposed in corresponding plugging grooves; and
an optical-electrical transform module disposed within the chamber,
wherein when an electrical plug is plugged into the chamber, the first contact portion is electrically connected to the second contact portion through the electrical plug so that the identity unit can drive the electrical signal terminal to transmit electrical signals, and when an optical fiber plug is plugged into the chamber, the optical-electrical transform module can transmit optical signals.

2. The coexistent optical-electrical connector of claim 1, wherein the connector further comprises a base having a plurality of through holes such that the insulating housing is disposed on the base and the through holes serve as positioning guides for the insertion of the electrical signal terminals.

3. The coexistent optical-electrical connector of claim 1, wherein the connector further comprises a shielding housing that encapsulates the insulating housing.

4. The coexistent optical-electrical connector of claim 1, wherein the optical-electrical transform module further comprises an optical-electrical transform device aligned with the insertion hole so that the optical fiber plug and the optical-electrical transform device form an optical-electrical transform circuit when the optical fiber plug is inserted into the chamber.

5. The coexistent optical-electrical connector of claim 4, wherein the optical-electrical transform module further comprises a plurality of signal terminals for transmitting the signal from the optical-electrical transform device.
